(19) United States
(12) Patent Application Publication
(10) Pub. No.: US 2010/0058644 A1
(43) Pub. Date: Mar. 11, 2010

(54) FISHING LURE

(76) Inventor: Elmer B. Wulf, Naperville, IL (US)

Correspondence Address: HARTMAN & HARTMAN, P.C., 552 EAST 700 NORTH, VALPARAISO, IN, 46383, US

(21) Appl. No.: 12/208,530

(22) Filed: Sep. 11, 2008

(51) Int. Cl. A01K 85/02; A01K 83/02

(52) U.S. Cl. 43/35; 43/36

(57) ABSTRACT

A fishing lure with retractable-deployable hooks that deploy when a fish takes the lure into its mouth, and a lure body configured to induce a swimming action with a diving capability. The lure body has nose and tail portions and dorsal, ventral and lateral sides. The tail portion has an airtight cavity therein and is lighter than the nose portion such that the lure tends to dive downward when drawn through water. One or more forward hooks are located on the ventral and/or lateral sides of the lure body, and at least one tail hook is located on the tail portion of the lure body. The hooks each have a deployed position wherein its point is exposed outside the lure body for hooking a fish. Each hook further has a stowed position wherein its point is sufficiently retracted to avoid being snagged as the lure is drawn through water.

### CROSS REFERENCE TO RELATED APPLICATIONS

This application is related to U.S. Provisional Application No. 60/595,336, the contents of which are incorporated herein by reference.

### BACKGROUND OF THE INVENTION

The present invention generally relates to fishing lures, and more particularly to a fishing lure with retractable-deployable hooks that deploy when a fish takes the lure into its mouth.

Conventional lures typically have two or more treble hooks that hang from the bottom (ventral side) of the lure. At this location, the hooks readily snag obstacles such as rocks, weeds, trash, or any other type of debris in the water. Because fish will not strike a lure with debris hanging from one of its hooks, and lures can become irretrievably snagged on obstacles, anglers will typically avoid using lures in waters where obstacles are likely to be encountered.

In view of the above, lures with deployable hooks have been proposed. Examples include U.S. Pat. No. 1,009,538 to Lowe, U.S. Pat. No. 1,204,538 to Belding, U.S. Pat. No. 2,439,391 to Jobson, U.S. Pat. No. 2,474,383 to Suhr, U.S. Pat. No. 2,544,782 to Fawcett, U.S. Pat. No. 5,526,602 to Day, Sr., and U.S. Pat. No. 5,878,524 to Braden, which disclose lures with hooks that are concealed under the force of a spring, and whose force is overcome to permit deployment of the hooks when a fish grasps and pulls rearward (aftward) on the lure. Of these, Belding, Jobson, Suhr, Fawcett, and Day, Sr. include further hooks that deploy laterally from their bodies. Lures with other types of deployment mechanisms have also been proposed. U.S. Patent No. 945,091 to Hanel, U.S. Pat. No. 1,318,073 to Gottschalk, U.S. Pat. No. 1,355,858 to Smith, U.S. Pat. No. 2,700,842 to Lehmann, U.S. Pat. No. 2,729,013 to Chandler, U.S. Pat. No. 3,018,582 to Anderson, and U.S. Pat. No. 3,816,953 to Hameen-Antila disclose lures equipped with hooks that are concealed within the lure body and deploy when the mouth of a fish squeezes a lever on the exterior of the lure, releasing a spring-loaded shaft that moves aftward to deploy the hooks from the tail of the lure body. Anderson further discloses a side hook that is deployed laterally outward from the lure body.

### BRIEF DESCRIPTION OF THE INVENTION

The present invention provides a fishing lure with retractable-deployable hooks that deploy when a fish takes the lure into its mouth, and a lure body configured to induce a swimming action with a diving capability.

According to a first aspect of the invention, the fishing lure includes a lure body having a nose and an oppositely-disposed tail, a nose portion adjacent the nose, a tail portion adjacent the tail, oppositely-disposed dorsal and ventral sides, and oppositely-disposed lateral sides. The nose portion has a feature for attaching a first fishing line to the lure body, and the ventral side has a feature for attaching a second fishing line to the lure body at an approximate fore-aft balance point of the lure body. The tail portion has an airtight cavity therein and is lighter than the nose portion such that the lure body dives downward when drawn through water by the first fishing line attached to the nose portion. At least a first forward hook is located on the ventral and/or lateral sides of the lure body, and at least one tail hook is located on the tail portion of the lure body. The first forward hook and tail hook each have a deployed position wherein points of the forward and tail hooks are exposed outside the lure body for hooking a fish. The first forward hook and tail hook further have a stowed position wherein the points of the forward and tail hooks are sufficiently retracted to avoid being snagged as the lure is drawn through water.

According to a second aspect of the invention, the fishing lure further includes a mechanism for rapidly deploying the forward and tail hooks from their stowed positions to their deployed positions. The deploying mechanism includes a lever outside of the lure body and a shaft at least partially within the lure body. The lever is operable to actuate the shaft in an aft direction. The shaft has a fore portion coupled to the first forward hook and an aft portion extending from the lure body and coupled to the tail hook.

In view of the above, it can be seen that the airtight cavity within the tail portion of the lure provides for a swimming action that can include a diving action by appropriately working the lure with a fishing line attached to the nose of the lure. Furthermore, by attaching a weighted fishing line (for example, a leader with sinkers) to the attachment feature at the ventral side of the lure, the lure can be placed at or near the bottom of a body of water for bottom fishing. By removing the weighted fishing line, the size of the airtight cavity can be such that the lure floats for use at the water surface. According to a preferred aspect of the invention, when deployed the hooks resist being retracted or collapsed into the lure body by any squeezing action of the fish.

Other objects and advantages of this invention will be better appreciated from the following detailed description.

### BRIEF DESCRIPTION OF THE DRAWINGS

FIGS. 1 and 2 are fragmentary cross-sectional top and side views, respectively, of a fishing lure in a stowed/undeployed state in accordance with a preferred embodiment of this invention.

FIGS. 3 and 4 are fragmentary cross-sectional top and side views, respectively, of the fishing lure of FIGS. 1 and 2 in a deployed state in accordance with the preferred embodiment of this invention.

### DETAILED DESCRIPTION OF THE INVENTION

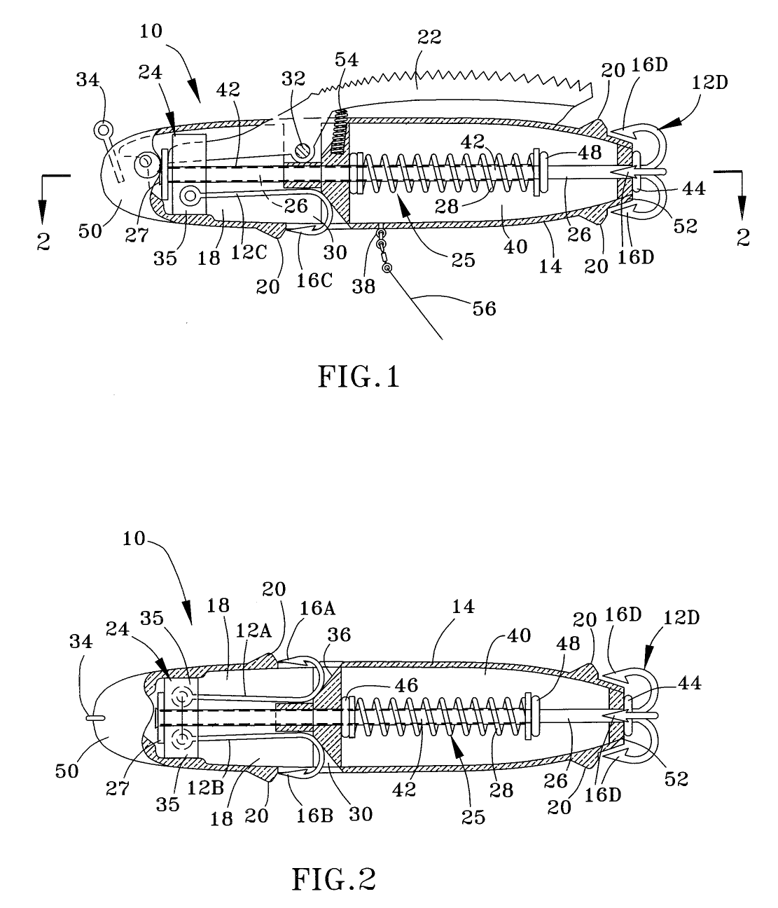

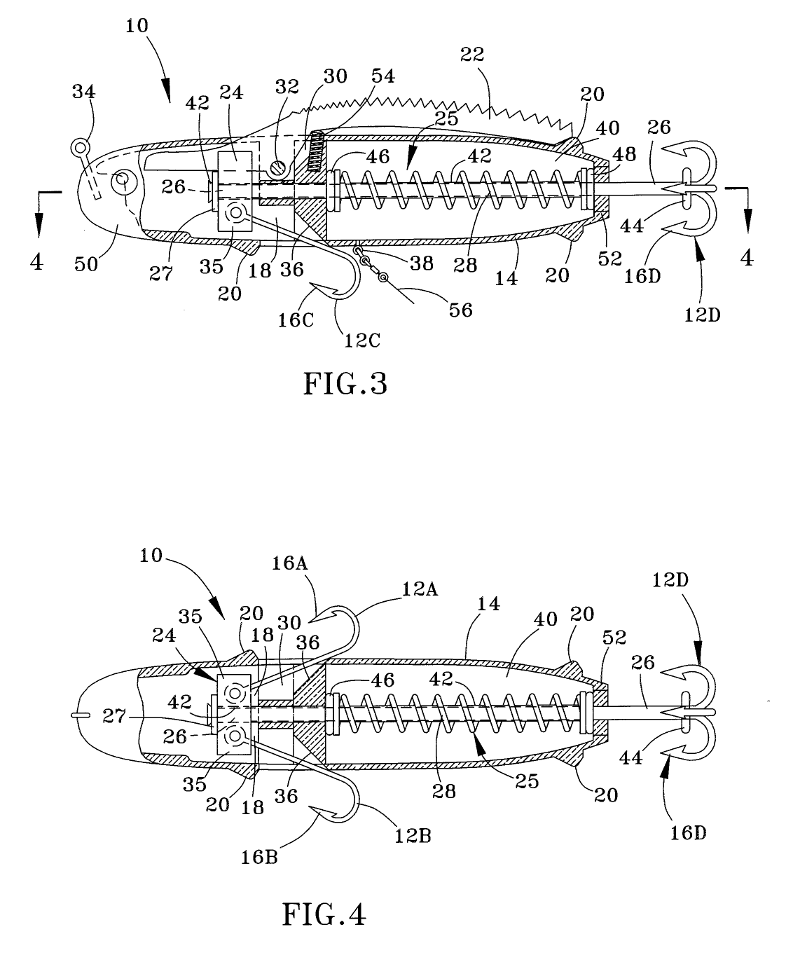

FIGS. 1 through 4 represent a fishing lure 10 within the scope of this invention. The lure 10 is intended to appear as a minnow, though other lure types are foreseeable.

The lure 10 is equipped with multiple concealed hooks 12A, 12B, 12C, and 12D that deploy when a fish takes the lure 10 into its mouth. In the embodiment represented in FIGS. 1-4, three forward hooks 12A-C (two lateral and one ventral) are represented as single hooks that are stowed within slots 18 defined within the lure 10, so that only their points 16A-C and the adjacent part of their bends are exposed outside the lure body 14. A small protrusion 20 can be provided in front of each point 16A-C to protect the forward hooks 12A-C from becoming snagged on debris as the lure 10 is drawn through the water. Alternatively, the forward hooks 12A-C could be stowed so that their points 16A-C are flush with or recessed beneath the outer surface of the lure body 14. The tail hook 12D is represented as a treble hook stowed against the rear portion of the lure body 14 so as not to protrude outside the profile of the lure 10 defined by its dorsal, ventral, and lateral extremities (as viewed from the front of the lure 10). As such, the tail hook 12D is unlikely to snag debris as the lure 10 is drawn through the water. Optionally, a small protrusion 20 can also be provided in front of each tail hook point 16D to protect the tail hook 12D from becoming snagged on debris. A shredded rubber tail (not shown) can be provided to hide the tail hook 12D. Similarly, the lure 10 can be equipped with small soft shredded tails (not shown) to hide the forward hooks 12A-C.

According to a preferred embodiment of the invention, the hooks 12A-D are deployed by the action of a trip lever 22 configured to resemble a dorsal fin. The lever 22 is biased with a spring 54 away from the lure body 14, and coupled with a pivot 32 (or other suitable pivoting means) to a fixed sleeve 30 that defines a wall within the lure body 14. The lever 22 is operable to actuate a shaft assembly 25 that comprises a disk 24, shaft 26, washer 27, spring 28, and tube 42. A fore portion of the shaft 26 is within and coupled to the tube 42, an aft end of the shaft 26 protrudes from the tube 42, and the disk 24 and washer 27 are mounted on the tube 42. The shaft assembly 25 is biased aftwardly within the lure body 14 by the spring 28. The fore end of the lever 22 forward of the pivot 32 is received in a slot defined in the disk 24 and engages the washer 27 at the fore end of the shaft assembly 25. The forward hooks 12A-C are pivotally attached to the disk 24 and slidable within their respective slots 18, each of which includes a contiguous slot 35 within the disk 24 that receives the upper shank of the hook 12A-C, and a contiguous and sloping camming surface 36 defined in the sleeve 30 that receives the lower shank and bend of the hook 12A-C. The tail hook 12D is attached to the aft end of the shaft 26, which protrudes from the lure body 14 through an 0-ring 44 or other type of element to create an airtight seal between the shaft 26 and the lure body 14. The engagement of the fore end of the lever 22 with the washer 27 rigidly holds and effectively locks the hooks 12A-D in the stowed position until released by the lever 22. While the hooks 12A-D are held in the stowed position, the O-ring 44 on the shaft 26 seals against the outer surface of the lure body 14 at the tail 52, preventing ingress of water into the body 14. Another O-ring 46 seals the joint between the tube 42 and the sleeve 30.

Movement of the lever 22 toward the lure body 14 causes the fore end of the lever 22 to disengage the washer 27, allowing aftward movement of the shaft 26 caused by the spring 28 to deploy the hooks 12A-C aftwardly and then outwardly as the shanks of the hooks 12A-C cam against their respective camming surfaces 36, and deploys the tail hook 12D aftwardly away from the lure body 14. Once the hooks 12A-D are deployed, the spring 28 biases the forward hooks 12A-C firmly against their respective camming surfaces 36 to effectively lock the hooks 12A-C in their deployed positions, preventing (or at least greatly inhibiting) the hooks 12A-C from being retracted or collapsed into the lure body 14 by the action of the fish. This capability of rigidly holding the hooks 12A-C in the deployed position is preferred to greatly facilitate removal of the hooks 12A-C from a fish's mouth. The spring 28 also holds a third O-ring 48 on the shaft 26 against the internal surface at the end of the lure body 14, preventing ingress of water into the body 14.

A safety feature of the lure 10 is that the concealed hooks 12A-D are deployed aftwardly as they exit the lure body 14, reducing the risk to the angler if the hooks 12A-D are accidentally released. Furthermore, the fulcrum point of the trip lever 22, as defined by the pivot 32, is preferably located close to the nose 50 of the lure 10 to reduce the risk of prerelease of the hooks 12A-D caused from collisions with objects on or near the water bottom. To increase the likelihood that the lever 22 will preferentially trip due to the action of a fish squeezing the lever 22 instead of a forward collision with an obstacle, a suitable ratio for the length of the lever 22 fore and aft of the pivot 32 is believed to be about 1:2, for example, about one inch (about 2.5 cm) from the forward end of the lever 22 to the pivot 32, and about two inches (about 5 cm) from the pivot 32 to the aft end of the lever 22.

The spring 28 is preferably of sufficient strength to achieve a very rapid hook deployment upon actuation of the lever 22 by a fish, and to rigidly hold the hooks 12A-D in their deployed positions to facilitate removal of the lure 10 from a fish's mouth. Moving parts of the lure 10 and parts that engage moving parts, such as the disk 24, shaft 26, sleeve 30 and its camming surfaces 36, are preferably machined to close tolerances and formed of a lightweight, low-friction, and wear-resistant material, such as a thermoplastic commercially available under the name DELRIN® from DuPont. The trip lever 22 is preferably a rigid arm concealed in a soft rubber fin. For example, the lever 22 can be formed of one-eighth inch (about 3 mm) thick DELRIN®. The slots 18 and 35 and camming surfaces 36 for the forward hooks 12A-C are sufficiently wide to slidably guide the hooks 12A-C, for example, about one-sixteenth inch (about 1.5 mm) in width. Deployment of the hooks 12A-D can be achieved with relatively little travel of the shaft 26, for example, about one-half inch (about 1.3 cm), resulting in aftward travel of the tail hooks 12D of the same distance. Assembly of certain components of the lure 10 can be with a waterproof glue or other suitable means.

The lure body 14 may be a hollow plastic shell or have another lightweight and hollow construction. The body 14 of the lure 10 may be transparent or translucent to permit viewing of the internal components in action, and to allow for testing to make adjustments and improvements. All or part of the lure body 14 can be painted any combination of colors suitable for fishing.

The lure 10 preferably provides a swimming action created in part as a result of an airtight cavity 40 within the lure body 14 aft of the sleeve 30, such that the tail portion of the lure 10 (that portion of the lure 10 aft of the sleeve 30) is lighter than the nose portion of the lure 10 (that portion of the lure 10 starting at the nose 50 and aftward to and including the sleeve 30). As a result, the tail 52 tends to float relative to the nose 50, and the nose 50 tends to sink relative to the tail 52. The dorsal side of the lure nose 50 is equipped with an eyelet 34 for attaching a fishing line (not shown), and the ventral side of the lure 10 is equipped with an eyelet 38 near its fore-aft balance point for attaching a leader 56 with heavy sinkers (not shown). The balance point is located near the sleeve 30 between the nose-tail portions of the lure body 14, and defines the location at which the weight of the lure 10 forward of the balance point is equal to the weight of the lure 10 aft of the balance point. With a sufficient number of sinkers (e.g., one-ounce South Bend sinkers) attached to the lure 10 with the eyelet 38, the lure 10 can be sunk for fishing at or near the bottom. The length of the leader 56 can be used to determine the height of the lure 10 off the bottom. By unsnapping and removing the leader 56, the lure 10 floats to or near the water surface as a result of the airtight cavity 40 to allow surface fishing with the lure 10.

The angler's retrieval of the lure 10 determines the lure action. Because the nose 50 of the lure 10 points down as a result of the buoyancy of the tail 52, the lure 10 tends to dive while traveling forward. While surface and bottom fishing, rod action can be used to pull the nose 50 up and laterally from side to side to give the lure 10 a swimming action. The lure 10 thus provides double-action for both bottom or surface fishing with an up-down and/or side-to-side action.

While the lure 10 is capable of luring a wide variety of fish, including northern pike, walleye, muskellunge, etc., its design is particularly well-suited for fishing lunker bass when they are resting on the bottom of a body of water and not biting in the shallow water. For this purpose, suitable dimensions for the lure 10 are about 4⅛ inch (about 10.5 cm) in length and about ¾ inch (about 2 cm) in diameter. The three forward hooks 12A-C preferably do not distort or bend when deployed out and away from the lure body 14 by the shaft assembly 25 and its spring 28. Preferred materials for the hooks 12A-D include hardened alloy steel, which may be coated to inhibit corrosion. The lateral forward hooks 12A and 12B may have an approximately 1.5 inch (about 4 cm) spread from point to point across the lateral width of the lure 10, which is sufficiently wide to catch and hold big lunker bass. When a fish tries to disgorge the lure 10, the three forward hooks 12A-C penetrate deeper into the fish jaws and secure the fish to the lure 10 for retrieval and landing. Removal of the lure 10 can be performed with long-nosed pliers. Though shown with barbs, the hooks 12A-D may be barbless to facilitate removal of the lure 10.

Use of the lure 10 involves stowing the hooks 12A-D and securing them in their stowed positions by engaging the washer 27 with the lever 22. Stowing the hooks 12A-D can be performed by placing the nose 50 of the lure 10 in the palm of one hand and the tail hook 12D in the palm of the other hand, and then pushing the tail hook 12D into the lure body 14 until the lever 22 “clicks” into its closed/latched position against the washer 27. Notably, and as previously described, the hooks 12A-C are effectively locked in their stowed position by the lever 22, as well as locked in their deployed position by their respective camming surfaces 36. This two-position (bidirectional) locking capability of the invention is believed to be very desirable from the standpoint of safety and functionality, and the lever 22 and camming surfaces 36 are believed to be simple and effective mechanisms for achieving the two-position locking action. However, those skilled in the art will be capable of devising other mechanisms that are capable of providing a two-position locking action, for example, other types of latches, levers, cams, springs, toggles, etc., and all such mechanisms are within the scope of this invention.

With the hooks 12A-D stowed, the lure 10 can be used without snagging obstacles such as rocks, mud, trash, weeds and grass beds where big lunker fish are likely to be feeding, hiding or resting. With the leader 56 and its sinkers attached to the lower ventral eyelet 38, the lure 10 can be configured for bottom or deep-water fishing. Reducing the weight on the leader 56 or completely removing the leader 56 allows the lure 10 to be rigged for use in shallow water or surface casting. When a fish strikes the lure 10, the trip lever 22 releases the spring-loaded hooks 12A-D into the mouth of the fish. The angler feels the fish strike through the line to his rod tip, and sets the hooks 12A-D to retrieve the fish. Once the fish is retrieved, the hooks 12A-D can be removed from the fish's mouth, which is facilitated by the hooks 12A-C being rigidly held in the deployed position by their camming surfaces 36. Once removed, the lure 10 can be easily reset as described above to continue fishing. The angler also has the option of using the lure 10 with the hooks 12A-D deployed, much like a conventional lure, but with the hooks 12A-C locked in their deployed positions. The lure 10 can also carry live bait with the hooks 12A-D open or closed.

While the invention has been described in terms of a preferred embodiment, it is apparent that other forms could be adopted by one skilled in the art. For example, the physical configuration of the lure 10 could differ from that shown, materials and processes other than those noted could be used, and functionally-equivalent components and structures could be used to achieve the bias-actuation, dive-action, and airtight capability of the lure 10. Therefore, the scope of the invention is to be limited only by the following claims.

1. A fishing lure comprising:
a lure body having a nose and an oppositely-disposed tail, a nose portion adjacent the nose, a tail portion adjacent the tail, oppositely-disposed dorsal and ventral sides, and oppositely-disposed lateral sides, the nose portion having means for attaching a fishing line to the nose portion of the lure body, the ventral side having means for attaching a leader to the lure body at an approximate fore-aft balance point of the lure body, the tail portion having an airtight cavity therein and being lighter than the nose portion such that the lure body dives downward when drawn through water by the fishing line attached to the nose portion;
at least a first forward hook located on at least one of the ventral and lateral sides of the lure body and at least one tail hook located on the tail portion of the lure body, the first forward hook and tail hook having a deployed position wherein points of the forward and tail hooks are exposed outside the lure body for hooking a fish, the first forward hook and tail hook having a stowed position wherein the points of the forward and tail hooks are sufficiently retracted to avoid being snagged as the lure is drawn through water;
a leader attached to the leader attaching means; and
at least one sinker attached to the leader;
wherein the fishing lure sinks in water from the weight of the leader and the sinker, and the fishing lure floats in water in the absence of the leader and the sinker as a result of the airtight cavity.

2. The fishing lure according to claim 1, further comprising means for rapidly deploying the forward and tail hooks from their stowed positions to their deployed positions, the deploying means comprising a lever located at the dorsal side of the lure body and extending aftward, a pivot pivotally connecting the lever to the lure body, a shaft means, and means for biasing the shaft means in an aft direction of the lure body. the shaft means having a fore portion to which the first forward hook is pivotally attached and an aft portion extending from the lure body and coupled to the tail hook, the lever having a rearward end outside the lure body and a forward end within the lure body and engageable with the fore portion of the shaft means for securing the shaft means in a fore direction of the lure body and disengageable with the fore portion of the shaft means for releasing the shaft means for actuation by the biasing means in an aft direction of the lure body.

3. A fishing lure comprising:
a lure body having a nose and an oppositely-disposed tail, a nose portion adjacent the nose, a tail portion adjacent the tail, oppositely-disposed dorsal and ventral sides, and oppositely-disposed lateral sides, the nose portion having means for attaching a fishing line to the nose portion of the lure body, the ventral side having means for attaching a leader to the lure body at an approximate fore-aft balance point of the lure body, the tail portion having an airtight cavity therein and being lighter than the nose portion such that the lure body dives downward when drawn through water by the fishing line attached to the nose portion;
at least a first forward hook located on at least one of the ventral and lateral sides of the lure body and at least one tail hook located on the tail portion of the lure body, the first forward hook and tail hook having a deployed position wherein points of the forward and tail hooks are exposed outside the lure body for hooking a fish, the first forward hook and tail hook having a stowed position wherein the points of the forward and tail hooks are sufficiently retracted to avoid being snagged as the lure is drawn through water; and
means for rapidly deploying the forward and tail hooks from their stowed positions to their deployed positions, the deploying means comprising a lever located at the dorsal side of the lure body and extending aftward, a pivot pivotally connecting the lever to the lure body, a shaft means, and means for biasing the shaft means in an aft direction of the lure body, the shaft means having a fore portion to which the first forward hook is pivotally attached and an aft portion extending from the lure body and coupled to the tail hook, the lever having a rearward end outside the lure body and a forward end within the lure body and engageable with the fore portion of the shaft means for securing the shaft means in a fore direction of the lure body and disengageable with the fore portion of the shaft means for releasing the shaft means for actuation by the biasing means in an aft direction of the lure body, wherein the forward and rearward ends of the lever are forward and rearward, respectively, of the pivot, the lever has a forward length forward of the pivot and a rearward length rearward of the pivot, and the forward and rearward lengths of the lever have a length ratio of about 1:2.

4. The fishing lure according to claim 3, wherein the first forward hook is located at the ventral side of the lure body, the lure further comprising a pair of forward hooks located at the lateral sides of the lure body.

5. The fishing lure according to claim 1, further comprising means for rapidly deploying the forward and tail hooks from their stowed positions to their deployed positions, the deploying means comprising a lever located at the dorsal side of the lure body and a pivot pivotally connecting the lever to the lure body, the lever having forward and rearward ends that are, respectively, within and outside the lure body, the lever having a forward length forward of the pivot and a rearward length rearward of the pivot, and the forward and rearward lengths of the lever having a length ratio of about 1:2.

6. The fishing lure according to claim 3, wherein the attaching means at the nose portion is located on the dorsal side thereof.

7. The fishing lure according to claim 3, wherein the deploying means further comprises a disk coupled with the fore portion of the shaft means, and the first forward hook is pivotally coupled to the disk so as to be released with the shaft means and be actuated by the biasing means in the aft direction of the lure body as a result of the forward end of the lever disengaging the fore portion of the shaft means.

8. The fishing lure according to claim 3, further comprising a fixed wall within the lure body and separating the nose and tail portions of the lure body.

9. The fishing lure according to claim 8, wherein the wall defines a surface of the airtight cavity within the tail portion.

10. The fishing lure according to claim 9, wherein the pivot of the lever is located on the wall.

11. The fishing lure according to claim 8, wherein the wall comprises a fixed camming surface configured to cause the first forward hook to deploy away from the lure body when the shaft means and the first forward hook coupled thereto are actuated by the biasing means in the aft direction of the lure body.

12. The fishing lure according to claim 11, wherein the fixed camming surface is contiguous with a slot defined in the lure body and in which a shank of the first forward hook is received.

13. The fishing lure according to claim 12, wherein the slot and the fixed camming surface are configured such that deployment of the first forward hook comprises an aftward movement of the first forward hook followed by an outward movement away from the lure body.

14. The fishing lure according to claim 3, further comprising a fixed camming surface configured to cause the first forward hook to deploy away from the lure body when the shaft means and the first forward hook coupled thereto are actuated by the biasing means in the aft direction of the lure body.

15. The fishing lure according to claim 14, wherein the biasing means biases the first forward hook against the fixed camming surface to lock the first forward hook in the deployed position thereof.

16. The fishing lure according to claim 14, wherein the fixed camming surface is contiguous with a slot defined in the lure body and in which a shank of the first forward hook is received.

17. The fishing lure according to claim 16, wherein the slot and the fixed camming surface are configured such that deployment of the first forward hook comprises an aftward movement of the first forward hook followed by an outward movement away from the lure body.

18. The fishing lure according to claim 3, wherein the first forward hook is stowed within a slot defined within the lure body so that the point thereof is exposed outside the lure body, the lure further comprising a protrusion forward of the point to protect the first forward hook from becoming snagged on debris as the lure is drawn through water.

19. The fishing lure according to claim 3, wherein the tail hook is stowed against the tail of the lure body 14 so as not to protrude outside a profile of the lure body defined by the dorsal, ventral, and lateral sides thereof.

20. The fishing lure according to claim 3, further comprising a leader attached to the leader attaching means and at least one sinker attached to the leader, wherein the fishing lure sinks in water from the weight of the leader and the sinker, and the fishing lure floats in water in the absence of the leader and the sinker as a result of the airtight cavity.
